(19) United States
(12) Patent Application Publication
(10) Pub. No.: US 2021/0111873 A1
(43) Pub. Date: Apr. 15, 2021

(54) REPEATED MODULO METHOD AND APPARATUS FOR SIZE-LIMITATION OF INTERIM CALCULATION RESULTS

(71) Applicant: Goke US Research Laboratory, Santa Clara, CA (US)

(72) Inventor: Chandra Varanasi, Santa Clara, CA (US)

(21) Appl. No.: 16/600,373

(22) Filed: Oct. 11, 2019

(51) Int. Cl. H04L 9/06; G06F 7/72

(52) U.S. Cl. CPC H04L 9/0668; G06F 7/722

(57) ABSTRACT

A method and apparatus for limiting the size of large numbers during numeric calculations, such as during encryption and decryption calculations.

### BACKGROUND

### I. Field of Use

The present invention relates to the field of computers and more specifically to a method and apparatus for limiting the size of interim results during computer calculations.

### III. Description of the Related Art

In cryptographic applications, relatively large numbers are frequently encountered. For example, digital encryption and decryption engines may operate on words that are 256-bits wide, 1024-bits wide or more. Performing calculations such as addition or multiplication on such large words often results in even larger word sizes, requiring computer memory that must accommodate the larger word sizes as a default word size, in order to prevent errors due to overflow. This typically requires memory sizes that are much larger than would otherwise be needed if the word sizes were smaller.

In some applications, an end result of an encryption or decryption operation is reduced to a smaller word size using, for example, modulo reduction techniques. It is wasteful in terms of computer memory to allow large, interim word sizes when the final encryption/decryption result will be a smaller word size.

Another related problem of large numbers is that the length of an input string is often unknown. Thus, memory and processing hardware must be selected based on a maximum value that an input string could be.

Thus, it would be desirable to limit the size of interim computer calculations in order to reduce the size and expense associated with having to use larger memories and processors.

### SUMMARY

The embodiments described herein relate to an apparatus and method for limiting the size of interim calculated results in a computer algorithm. In one embodiment, a method is described to limit the size of interim results in a cryptographic function, comprising mapping an unencrypted input into a cryptographic sentence based on a cryptographic alphabet, the cryptographic sentence comprising a plurality of symbols of the cryptographic alphabet and a sentence length based on the number of symbols in the cryptographic sentence, and a radix that defines the size of the cryptographic alphabet, generating a pseudo-random byte string based on a pseudo-random function, performing a modulo operation on each symbol in the byte string, and summing the result of each of the modulo operations together to form the interim result.

In another embodiment, an electronic device is described that performs a cryptographic function that limits the size of interim results of the cryptographic function, comprising an input for receiving unencrypted data, an output for providing encrypted data, a memory for storing processor-executable instructions, and a processor coupled to the input, the output and the memory, for executing the processor-executable instructions that causes the electronic device to map the unencrypted data into a cryptographic sentence based on a cryptographic alphabet, the cryptographic sentence comprising a plurality of symbols of the cryptographic alphabet and a sentence length equal to a number of symbols in the cryptographic sentence, and a radix that defines a size of the cryptographic alphabet, generate a byte string based on a pseudo-random function, perform a modulo operation on each symbol in the byte string, sum the result of each of the modulo operations together to form the interim result, use the interim result to generate the encrypted data, and provide the encrypted data to the output.

In yet another embodiment, a method is described, performed by an electronic device, for limiting the size of interim results of a format-preserving block cipher implemented by a processor within the electronic device, comprising receiving a string of unencrypted data for encrypting the string using a number of rounds, the string comprising symbols of a cryptographic alphabet, the cryptographic alphabet comprising a radix that defines a number of symbols in the cryptographic alphabet, for each round, calculating an integer limited in size to the radix raised to the power of the number of symbols in half the length of the string, and calculating an encrypted output based on the integer.

In still yet another embodiment, an electronic device is described that utilizes a format-preserving block cipher that limits interim results of the format-preserving block cipher, comprising an input for receiving unencrypted data, an output for providing encrypted data, a memory for storing processor-executable instructions, and a processor coupled to the input, the output and the memory, for executing the processor-executable instructions that causes the electronic device to receive, by the processor, the string of unencrypted data for encrypting the string using a number of rounds, the string comprising symbols of a cryptographic alphabet, the cryptographic alphabet comprising a radix that defines a number of symbols in the cryptographic alphabet, for each round, calculate an integer limited in size to the radix raised to the power of the number of symbols in half the length of the string, calculate an encrypted output based on the integer in each round, and provide the encrypted data to the output.

### BRIEF DESCRIPTION OF THE DRAWINGS

The features, advantages, and objects of embodiments of the present invention will become more apparent from the detailed description as set forth below, when taken in conjunction with the drawings in which like referenced characters identify correspondingly throughout, and wherein:

FIG. 1 is a simplified functional block diagram of an electronic device that performs encryption and decryption using the inventive concepts described herein;

FIG. 2 is a flow diagram illustrating one embodiment of a method performed by the electronic device of FIG. 1 to limit the size of interim results of a cryptographic function;

FIG. 3 is a conceptual block diagram of a Cipher Block Chaining mode of operation of AES encryption; and

FIG. 4 is a conceptual block diagram of a Feistel Network used to encrypt or decrypt data using the output of the Cipher Block Chaining mode of AES encryption.

### DETAILED DESCRIPTION

The embodiments described herein provide specific improvements to any computer algorithm that generates large, interim results by limiting the size of such interim results during interim calculations. In one embodiment, a cryptographic function is modified so that at least one interim result during encryption and decryption operations is limited in size using repeated modulo arithmetic. Two particular embodiments are described, each using a Format Preserving Encryption (FPE) algorithm.

The embodiments described herein rely on the following set of modulo reduction principles: (a) modulo reduction of addition of two numbers can be carried out as the addition of those two numbers individually, reduced modulo first, and (b) modulo reduction of a negative number can be accomplished as subtraction of the modulo reduction of the absolute value of the number from the modulus.

Regarding principle (a) for example:

(a+b)mod e=(a mod e)+(b mod e), where mod denotes modulo arithmetic.

As an example.

(27+39)mod 4=66 mod 4=2

The same result can be obtained as:

(27 mod 4)+(39 mod 4)=(3+3)mod 4=2

Additionally, this technique can be repeatedly applied to keep the word-size from growing. That is:

(a+b+c+d)mod e=((((((a mod e)+(b mod e))mod e)+(c mod e))mod e)+(d mod e))mod e.

As an example:

(27+39+134+267)mod 4=((((27 mod 4)+(39 mod 4))mod 4)+(134 mod 4))mod 4)+(267 mod 4))mod 4

Which equals:

((((3+3)mod 4+2)mod 4)+3)mod 4=((2+2)mod 4+3)mod 4=(0+3)mod 4=3

Using this technique results in seven modulo reduction operations, as opposed to only one modulo operation needed if the numbers are first added together. However, in practice, modulo arithmetic is relatively inexpensive to implement, and so the advantage of this method is that at no stage during the calculation does any integer that results after a modulo operation exceed the value of (e−1), where e is the modulus, in this example, 4. As such, no integer after a modulo operation is greater than (4−1)=3, which only requires a 2-bit representation. Performing the calculation, instead, by adding the numbers together first, before the modulo reduction, results in:

27+39+134+267=467

The integer 467 requires a 9-bit representation, requiring memory and processing hardware large enough to accommodate such a 9 bit representations.

Regarding principle (b), modulo reduction of negative numbers, as:

−a mod e=e−(a mod e)

this can be used to prevent having to compute growing negative numbers altogether. For example:

−24 mod 15=(15−(24 mod 15))=15−9=6

This approach brings modulo reduction operation of negative numbers back into a positive number less than the modulus.

These modulo techniques can be used to prevent large numbers during complex, interim calculations, for example, in cryptographic functions, as discussed below.

A particularly useful context in which the size-limiting modulo operation techniques described above may be used is in the field of cryptography. In particular, the techniques may be used in Format Preserving Encryption (FPE) algorithms, which utilize a block cipher for the cryptographic transformation of data, designed for data that is not necessarily binary.

For example, a Social Security number (SSN) consists of nine decimal numerals, so it is an integer that is less than one billion. This integer can be converted to a bit string as input to a prior art encryption engine, or mode, but when the output bit string is converted back to an integer, it may be greater than one billion, which would be too long for an SSN. If an FPE algorithm is used, however, the encrypted output is in the same format, including the length, as the original data. Thus, an FPE-encrypted SSN would be a sequence of nine decimal digits.

Two FPE algorithms are described in this disclosure, FF1 and FF3 to indicate that they are format-preserving, Feistel-based encryption algorithms, each modified with the inventive concepts described herein to limit the size of integers during interim calculations. However, it should be understood that the inventive concepts described herein could be applied to other cryptographic algorithms that do not feature FPE, or even to algorithms that do not perform cryptographic functions.

Both FF1 and FF3 operate on a string of unencrypted data comprising symbols of a non-binary alphabet. The size of the alphabet is called the radix. Among other things, these algorithms require an interim computation of a decimal number, or integer, that can become needlessly large. For example, if an alphabet comprises 26 symbols {a, b, c, . . . , z}, an unencrypted input string of symbols received by an encryption engine can first be mapped to a numeral string using the a mapping function a→0, b→1, c→2, . . . , z→25, resulting in a numeral alphabet of {0, 1, 2, . . . , 25}. This mapping allows every English sentence to be converted into a corresponding numeral string. For example, an unencrypted input, or “sentence” of the word “flower” would generate a numeral string of 5, 11, 14, 22, 4, 17 having a sentence length “L”, in this case, 6. As part of either of the FF1 or FF3 algorithm, an interim integer ‘y’ is normally calculated from that string with respect to the radix, possibly resulting in a large integer. For example, the string 5, 11, 14, 22, 4, 17 is converted to a decimal number, as follows:

y=5*265+11*264+14*263+22*26²+4*26+17=64,694,673, which is represented by 27 bits

However, at a later stage of the computation, each of the FF1 and FF3 algorithms reduce y by a modulo operation with a modulus=radix^{m}, where m represents half of L (the length of the input sentence f l o w e r), in this case, and the radix is 26:

y mod radix^{m}=64694673 mod 263=14,993, which is represented by 14 bits

There is no point in actually computing the large integer y (64694673) if this number is reduced later in the calculation by a modulo operation (i.e., yielding y=14,993), since the result will be the same using the size-limiting principles described above in paragraph 0014. Instead, y mod radix^{m} can be computed as the sum of individual members of the input string, each member reduced modulo (radix^{m}), and the size of y will never exceed radix^{m}. The advantage of limiting the size of y in these examples is that memories and processors can be selected that require fewer data lines to represent y, or some other number during interim calculations.

As an example, let d=radix^{m}, where radix=26 and m=3, as above. Then, d=17,576, and y mod d can be computed, using the technique described in paragraph 0014, above, as follows:

$$y mod d = ( 5 * {26}^{5} ) mod d + ( 11 * {26}^{4} ) mod d + ( 14 * {26}^{3} ) mod d + ( 22 * {26}^{2} ) mod d + ( 4 * 26 ) mod d + 17 mod d = ( 59 , 406 , 880 mod 17 , 576 ) + ( 5 , 026 , 736 mod 17 , 576 ) + ( 246 , 064 mod 17 , 576 ) + ( 14 , 872 mod 17 , 576 ) = ( 104 mod 17 , 576 ) + ( 16 mod 17 , 576 ) = 0 + 0 + 0 + 14 , 872 + 104 + 17 = 14 , 993 ( which can be represented by 14 bits )$$

In addition to not letting the word-length for ‘y’ grow, this approach also provides a benefit of not having to know the maximum possible length L of a sentence. In practice, the sentence length L may not be known in advance, which could allow “y” to grow very large, requiring hardware that can process the maximum value that y, or some other variable, could potentially reach. Since modulo circuitry or code is generally used in many cryptographic functions today, repeatedly invoking such a modulo operation in this embodiment would not require any further circuitry or code—only repeatedly invoking the existing modulo circuit(s) or code.

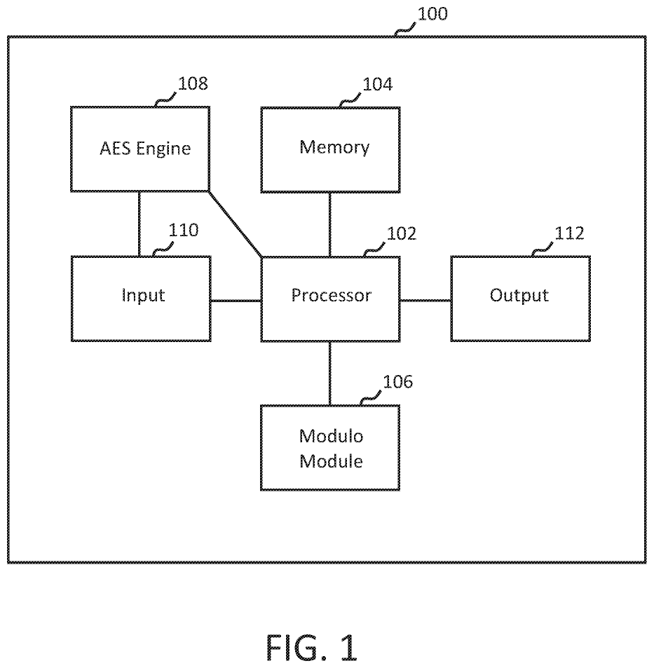

FIG. 1 is a simplified functional block diagram of an electronic device 100, comprising processor 102, memory 104, modulo module 106, AES Engine 108, input 110 and output 112. Electronic device 100 comprises one of a wide variety of electronic devices, such as a desktop/laptop/tablet computer, computer server, digital camera or other digital recording device, or any other device that performs calculations resulting in large numbers. It should be understood that in other embodiments, the functional blocks shown in FIG. 1 could be coupled together in different ways and that some functional blocks have been omitted for purposes of clarity.

Processor 102 is configured to provide general operation of electronic device 100 by executing processor-executable instructions stored in memory 104, for example, executable computer code. Processor 102 is also responsible for encrypting and/or decrypting data received via input 110. Processor 102 comprises one or more general or specialized microprocessors, microcontrollers, and/or customized ASICs, selected based on computational speed, cost, power consumption, and other factors relevant to the performance and operational requirements of electronic device 100.

Memory 104 is coupled to processor 102 and comprises one or more non-transitory information storage devices, such as RAM, ROM, flash memory, or other type of electronic, optical, or mechanical memory. Memory 104 is used to store processor-executable instructions for operation of electronic device 100, as well as other data, such as fixed or variable parameters, cryptographic keys, cryptographic algorithms, etc. A portion of memory 104 may be reserved as “registers” to store certain data or interim calculations frequently used in association with encryption algorithms, for example, registers to temporarily store the results of each stage of AES encryption, and/or results of each round of a Feistel Network. It should be understood that in some embodiments, a portion of memory 104 may be embedded into processor 102 and, further, that host memory 104 excludes media for propagating signals.

Modulo module 106 is coupled to processor 102 and is used to perform modulo operations for calculations performed by processor 102. In other embodiments, the functionality of modulo module 106 is configured as sub-set of the processor-executable instructions stored in memory 104 and performed by processor 102. Modulo module 106 comprises circuitry to perform modulo addition and/or subtraction on various results from processor 102 as processor 102 performs encryption or decryption operations.

AES engine 108 is coupled to processor 102 and is used to generate a pseudo-random function (PRF) for use in a Feistel Network. AES engine 108 comprises one or more microprocessors, microcontrollers, custom ASICs, and supporting circuitry in accordance with the well-known AES (Advanced Encryption Standard) standard. In one embodiment, AES engine 108 is configured to perform a Cipher Block Chaining mode of operation of AES in order to generate the PRF.

Input 110 comprises circuitry and/or hardware (such as a connector or port) to receive unencrypted data from either a source within electronic device 100 (such as a keypad, camera, audio circuitry, other processor, etc.), or a source external to electronic device 100 (such as a remote computer, server, or other electronic device that is physically distinguished from electronic device 100. Such circuitry and/or hardware is well known in the art. In some embodiments, input 110 receives unencrypted/encrypted data in the form of strings. In other embodiment, input 110 receives unencrypted/encrypted data in other forms and converts the unencrypted/encrypted data into strings for input to processor 102 for encryption and/or decryption.

Output 112 comprises circuitry and/or hardware (such as a connector or port) to provide unencrypted/encrypted data to either a source within electronic device 100 (such as a display, a network interface card, other processor, etc.), or a source external to electronic device 100 (such as a remote computer, server, or other electronic device that is physically distinguished from electronic device 100. Such circuitry and/or hardware is well known in the art.

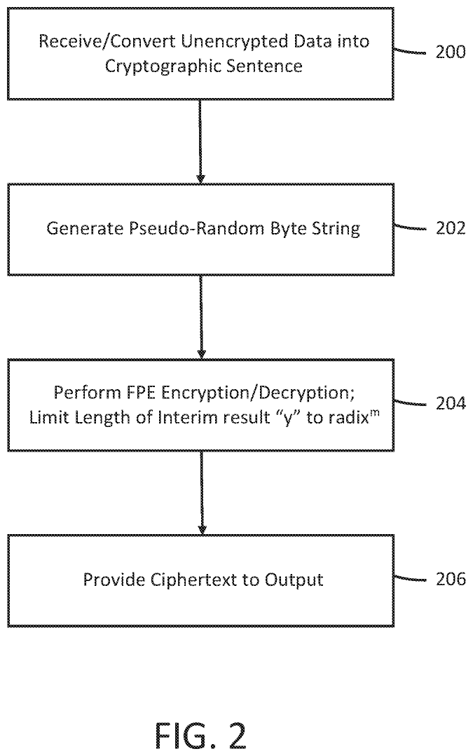

FIG. 2 is a flow diagram illustrating one embodiment of a method performed by electronic device 100 to limit the size of interim results of an algorithm executed by processor 102. In this embodiment, the method is described as applied to an FF1 mode of a format-preserving, Feistel-based encryption algorithm, stored as processor-executing instructions stored in memory 104. It should be understood that although the method shown in FIG. 2 describe one embodiment, the same inventive concepts can be applied to FF1 decryption, FF3 encryption and decryption, to other encryption/decryption methods, or even to applications outside of cryptography. It should be further understood that in some embodiments, not all of the steps shown in FIGS. 2A and 2B are performed and that the order in which the steps are carried out may be different in other embodiments. It should be further understood that some minor method steps have been omitted for purposes of clarity.

At block 200, unencrypted data is received by input 110 from a source internal or external to electronic device 100. The unencrypted data may be in the form of a serial string of non-binary data, where processor 102 converts, or maps, the string into a cryptographic sentence based on a cryptographic alphabet, the cryptographic sentence comprising a plurality of symbols of the cryptographic alphabet and a sentence length equal to the number of non-binary data received. The symbols of the cryptographic alphabet could comprise, for example, members a-z, 0-9, or some other arrangement of letters, numbers and/or symbols. The size of the cryptographic alphabet is referred to herein as the “radix”.

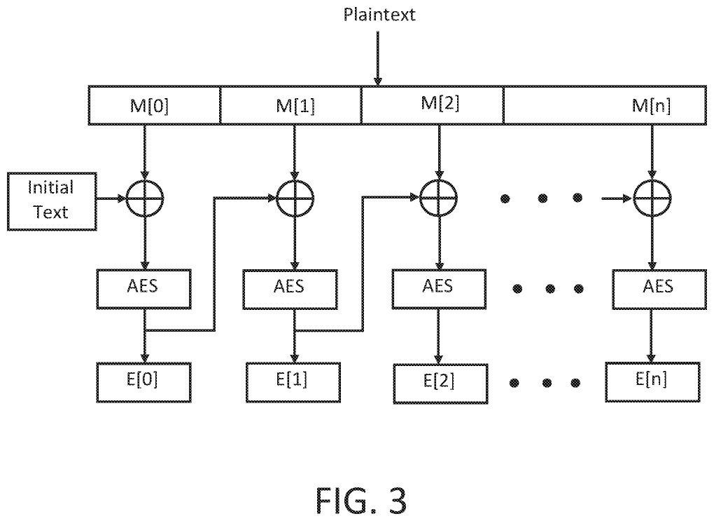

At block 202. AES engine 108 acts as a pseudo-random function (PRF) using, in one embodiment. Cipher Block Chaining mode of operation of AES encryption, as shown in the block diagram of FIG. 3. Other modes could be used in the alternative. The PRF forms part of a Feistel Network, as will be explained later herein.

Referring again to FIG. 3, a plaintext input string is received by processor 102 from input 110 and processor 102 distributes the string into a number of blocks M[0] through M[n], each block comprising a predetermined number of bits, such as 128, 192, 256, etc., depending on the type of AES encryption used. The string length may be more than the number of bits that are provided to blocks M[0] through M[n]. In this case, processor 102 simply uses a portion of the input string, selecting the number of bits required for the particular type of AES encryption being used. In other embodiments, processor 102 uses a source of input bits for the AES engine that is unrelated to the input string that is provided to the Feistel Network for encryption or decryption.

Block M[0] is first XORed with “initial text” which, in one embodiment, is an all-zero string. The output of the XOR function is then encrypted by processor 102 using, in this embodiment. AES, using a cryptographic key typically stored in memory 104. The output of the AES block (E[0]) is a first portion of ciphertext that represents the encrypted form of the plaintext input string, i.e., E[0] through E[n] are concatenated by processor 102 to form the entire ciphertext.

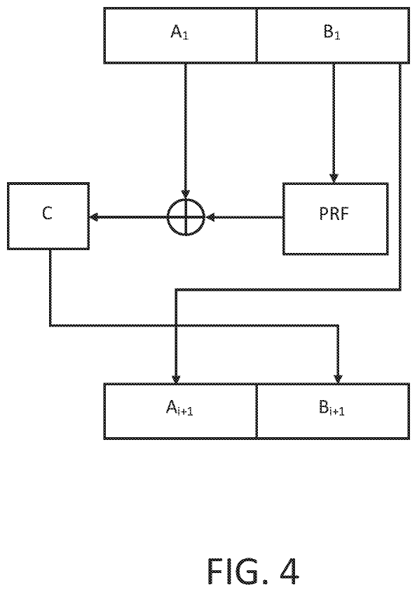

Next. E[0] is XORed with the next plaintext block, block M[1], by processor 102, and this process repeats until the last block M[n] is processed, resulting in E[n], as shown. E[n] comprises a pseudo-random byte string, used by a Feistel Network, as shown in FIG. 4 as part of the encryption or decryption process.

FIG. 4 shows a block diagram of a Feistel Network used to encrypt or decrypt data using the output of FIG. 3. E[n]. A Feistel Network or Feistel Cypher is a well-known structure for encryption and decryption, where data is processed in multiple rounds. The input of the i^{th} round consists of a string of n characters split into two equal-length halves: Aᵢ and Bᵢ. The PRF operates on Bᵢ to form a pseudo-random byte string that is applied to Aᵢ, i.e., by modulo addition, forming C. The next round begins with Aᵢ₊₁ set to Bᵢ and Bᵢ₊₁ equal to C. In some embodiments, an additional set of inputs is provided to the PRF in each round, such as a parameter T called Tweak, the round number, and n, the length of the input string. Further, since a Feistel Network is an invertible structure (even if PRF itself is not invertible). i.e.:

Bᵢ=Aᵢ₊₁ and Aᵢ=Bᵢ₊₁⊕PRF(Aᵢ₊₁) (where ⊕ is modulo addition)

That is why an AES decryption function is not needed—only AES encryption is needed to form the PRF. There is no need to invert PRF itself even when it is desired to generate (Aᵢ and Bᵢ) from (Aᵢ₊₁, Bᵢ₊₁).

At block 204, processor 102 performs FPE encryption of the plaintext input string in accordance with the FF1 algorithm below, shown in pseudo-code, which embodies both the PRF and Feistel Network concepts described above, except that steps 6(iv) and 6(iv) are modified as explained after the pseudo-code representation:

Step 1: Let n be the length of the input string X. Let u=└n/2┘ and v=n−u.
Step 2: Split X into A and B: A=X[1 . . . u] and B=X[u+1 . . . n]. (The notation X(1 . . . u) denotes the string of symbols X₁,X₂, . . . ,Xᵤ)
Step 3: Let b=┌┌v·log₂(radix)┐/8┐ (This is the number of bytes needed to represent the v symbols in B.)

### Step 4:

$$Let d = 4 ⌈ \frac{b}{4} ⌉ + 4$$

Step 5: Form the 16-byte String P as follows: P=[1]¹∥[2]¹∥[1]¹∥[radix]³∥[10]¹∥[u mod 256]¹∥[n]⁴∥[t]⁴. The notation [x]^{y} denotes y-byte representation of the decimal integer x, and ∥ denotes concatenation.
Step 6: Now Perform 10-Round Feistel Network operation
For (i=0: i<10; i++)
Step 6(i): Q=T∥[0]^{(-t-b-1)mod 16}∥[i]¹∥[NUM_{radix}(B)]^{b}. (NUM_{radix}(B) is the decimal number represented by the string B with respect to the base ‘radix’) As an example, if radix=10, and if B={6,7,8,4,3,5}, then NUM₁₀(B)=678435.
Step 6(ii): Let R=PRF(P∥Q)
Step 6(iii): Let S be the first d bytes of the string of ┌d/16┐ blocks:

R∥AES_{key}(R⊕[1]¹⁶)∥AES_{key}(R⊕[2]¹⁶) . . . AES_{key}(R⊕[┌d/16┐−1]¹⁶)

Step 6(iv): Let y=NUM(S) (Here, y is the decimal number represented by the byte string S, which could grow to a very large number.)
Step 6(v): If i is even, let m=u; if I is odd, let m=v.
Step 6(vi): Let c=(NUM_{radix}(A)+y) mod (radix^{m})
Step 6(vii): Let C=STR_{radix}^{m}(c)
Step 6(viii): Let A=B
Step 6(ix): Let B=C

### Step 7: Return A∥B

In one embodiment, step 6(iv) is replaced by the following:

y=((1^{st} byte of S)mod(radix^{m}))+((2^{nd} byte of S)mod(radix^{m})) . . . +((last byte of S)mod(radix^{m}))

In this way, y is a limited-sized integer which cannot exceed a size of radix^{m} and, thus, the maximum size of y is known a priori, allowing designers to limit the size and cost of hardware (such as processors and memory) needed to perform the algorithm.

In this embodiment, step 6(vi) is also modified to read as follows:

Let c=NUM_{radix}(A)+y

There is no longer a need to reduce the size of y in step 6(vi) using modulo arithmetic, since the size of y has already been limited at step 6(iv).

Similarly, the same concept can be applied to an FF3 encryption algorithm, as follows:

Step 1: Let n be the length of the input string X. Let u=┌n/2┐ and v=n−u.
Step 2: Split X into A and B: A=X[1 . . . u] and B=X[u+1 . . . n]. (The notation X(1 . . . u) denotes the string of symbols X₁,X₂, . . . ,Xᵤ)
Step 3: Let T_{L}=T[0 . . . 31] and T_{R}=T[32 . . . 63]
Step 4: Now Perform 8-Round Feistel Network operation
For (i=0: i<7; i++)
Step 4(i): If i is even, let m=u and W=T_{R}; if i is odd, let m=v and W=T_{L}.
Step 4(ii): P=W⊕[i]⁴∥[NUM_{radix}(REV(B))]¹². (REV(B) is simply the reversing of the string B.)
Step 4(iii): Let S=REVB(AES_{REVB(Key)}REVB(P)) (Here, REVB(P) is the byte-reversal of the byte-string P. That is, last byte of P is the 1^{st} byte in REVB(P))
Step 4(iv): Let y=NUM(S) (Here, y is the decimal number represented by the byte string S.)
Step 4(v): Let c=(NUM_{radix}(REV(A))+y) mod (radix^{m})
Step 4(vi): Let C=REV(STR_{radix}^{m}(c))
Step 4(vii): Let A=B
Step 4(viii): Let B=C

### Step 5: Return A∥B

Here, as in step 6(iv) with respect to FF1 encryption, step 4(iv) is replaced with:

y=((1^{st} byte of S)mod(radix^{m}))+((2^{nd} byte of S)mod(radix^{m})) . . . +((last byte of S)mod(radix^{m}))

And step 4(v) is replaced with:

c=NUM_{radix}(REV(A))+y

Again, similar to y in FF3, the value of y is not permitted to become larger than radix and, therefore, no modulo operation is performed by processor 102 at step 6(v).

Furthermore, the modulo-reducing operations described above can be used in FF1 and FF3 decryption algorithms. In FF1 decryption using the interim modulo size-limiting techniques described above, step 6 is shown below (steps 1-5 and 7 remain the same as in FF1 encryption):

Step 6: Perform 10-Round Feistel Network operation
For (i=9: i>=0; i−−) (Notice the decreasing value of I in the loop index. (This is the difference with respect to encryption.)
Step 6(i): Q=T∥[0]^{(-t-b-1) mod 16}∥[i]¹∥[NUM_{radix}(A)]^{b}. (NUM_{radix}(A) is the decimal number represented by the string A with respect to the base ‘radix’). As an example, if radix=10, and if A={6,7,8,4,3.5}, then NUM₁₀(A)=678435.
Step 6(ii): Let R=PRF(P∥Q)
Step 6(iii): Let S be the first d bytes of the string of ┌d/16┐ blocks:

R∥AES_{key}(R⊕[1]¹⁶)∥AES_{key}(R⊕[2]¹⁶) . . . AES_{key}(R⊕[┌d/16┐−1]¹⁶)

Step 6(iv): Let y=((1^{st} byte of S) mod (radix^{m}))+((2^{nd} byte of S) mod (radix^{m})) . . . +((last byte of S) mod (radix^{m}))
Step 6(v): If i is even, let m=u; if I is odd, let m=v.
Step 6(vi): Let c=NUM_{radix}(B)−y
Step 6(ii): Let C=STR_{radix}^{m}(c)
Step 6(iii): Let B=A
Step 6(ix): Let A=C

Note that steps 6(iv) and 6(vi) have been modified so that y is limited in length to radix^{m} at step 6(iv), and no modulo operation is performed at step 6(vi). The only difference between FF1 encryption and FF1 decryption is that “i” is decremented each time the loop is performed, and in step 6(vi), y is subtracted from NUM_{radix}(B), rather than added to NUM_{radix}(A).

Finally, the modulo-reducing operations described above can be used in FF3 decryption algorithms, as shown below (steps 1-3 and 5 remain the same as in FF3 encryption):

Step 4: Now Perform 8-Round Feistel Network operation
For (i=7: i>=0; i−−) (Note the decreasing i index)
Step 4(i): If i is even, let in =u and W=T_{R}; if i is odd, let m=v and W=T_{L}.
Step 4(ii): P=W⊕[i]₄∥[NUM_{radix}(REV(B))]¹². (REV(B) is simply the reversing of the string B.)
Step 4(iii): Let S=REVB(AES_{REVB(Key)}REVB(P)) (Here, REVB(P) is the byte-reversal of the byte-string P. That is, last byte of P is the 1^{st} byte in REVB(P))
Step 4(iv): Let y=((1^{st} byte of S) mod (radix^{m}))+((2^{nd} byte of S) mod (radix^{m})) . . . +((last byte of S) mod (radix^{m}))
Step 4(v): Let c=NUM_{radix}(REV(B))−y
Step 4(vi): Let C=REV(STR_{radix}^{m}(c))
Step 4(vii): Let A=B
Step 4(viii): Let B=C

### Step 5: Return A∥B

Note that steps 4(iv) and 4(v) have been modified so that y is limited in length to radix^{m} at step 4(iv), and no modulo operation is performed at step 4(v). Again, the only difference between FF3 encryption and FF3 decryption is that “i” is decremented each time the loop is performed, and in step 4(v), y is subtracted from NUM_{radix}(REV(B)), rather than added to NUM_{radix}(REV(A)).

At step 206, processor 102 provides a ciphertext version of the input string, in this embodiment, in the same format and length as the plaintext input string.

Certain aspects and embodiments of this disclosure have been described, above. Some of these aspects and embodiments may be applied independently and some of them may be applied in combination as would be apparent to those of skill in the art. In the following description, for the purposes of explanation, specific details are set forth in order to provide a thorough understanding of embodiments of the invention. However, it will be apparent that various embodiments may be practiced without these specific details. The figures and description are not intended to be restrictive.

The above description provides exemplary embodiments only, and is not intended to limit the scope, applicability, or configuration of the disclosure. Rather, the above description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the above description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The terms “computer-readable medium”, “memory” and “storage medium” includes, but is not limited to, portable or non-portable storage devices, optical storage devices, and various other mediums capable of storing, containing, or carrying instruction(s) and/or data. These terms each may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, RAM. ROM, flash memory, disk drives, etc. A computer-readable medium or the like may have stored thereon code and/or machine-executable instructions that may represent a procedure, a function, a subprogram, a program, a routine, a subroutine, a module, a software package, a class, or any combination of instructions, data structures, or program statements. A code symbol may be coupled to another code symbol or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code, i.e., “processor-executable code”, or code symbols to perform the necessary tasks (e.g., a computer-program product) may be stored in a computer-readable or machine-readable medium. A processor(s) may perform the necessary tasks.

What is claimed is:

1. A method to limit the size of an interim result of a cryptographic function, comprising:
mapping an unencrypted input into a cryptographic sentence based on a cryptographic alphabet, the cryptographic sentence comprising a plurality of symbols of the cryptographic alphabet and a sentence length based on the number of symbols in the cryptographic sentence, and a radix that defines the size of the cryptographic alphabet;
generating a pseudo-random byte string based on a pseudo-random function;
performing a modulo operation on each symbol in the byte string; and
summing the result of each of the modulo operations together to form the interim result.

2. The method of claim 2, wherein performing a modulo operation on each symbol in the byte string comprises:
multiplying each symbol in the byte string by the radix raised to a respective power of the position of each respective symbol in the byte string; and
performing modulo arithmetic on the result of each multiplication with the radix as the modulus.

3. The method of claim 1, wherein the cryptographic function comprises a format preservation encryption algorithm in accordance with an FF1 mode, wherein a variable “y” of the FF1 mode in step 6(iv) is limited in size to radix^{m}, where m is half the length of the cryptographic sentence.

4. The method of claim 3, wherein the modulo operation described at step 6(vi) of the FF1 mode is not performed.

5. The method of claim 1, wherein the cryptographic function comprises a format preservation encryption algorithm in accordance with an FF3 mode, wherein a variable “y” of the FF3 mode in step 4(iv) is limited in size to radix^{m}, where m is half the length of the cryptographic sentence.

6. The method of claim 5, wherein the modulo operation described at step 4(v) of the FF3 mode is not performed.

7. An electronic device that performs a cryptographic function that limits the size of interim results of the cryptographic function, comprising:
an input for receiving unencrypted data;
an output for providing encrypted data;
a memory for storing processor-executable instructions; and
a processor coupled to the input, the output and the memory, for executing the processor-executable instructions that causes the electronic device to:
map the unencrypted data into a cryptographic sentence based on a cryptographic alphabet, the cryptographic sentence comprising a plurality of symbols of the cryptographic alphabet and a sentence length equal to a number of symbols in the cryptographic sentence, and a radix that defines a size of the cryptographic alphabet;
generate a byte string based on a pseudo-random function;
perform a modulo operation on each symbol in the byte string;
sum the result of each of the modulo operations together to form the interim result;
use the interim result to generate the encrypted data; and
provide the encrypted data to the output.

8. The electronic device of claim 7, wherein the processor-executable instructions that causes the electronic device to perform a modulo operation on each symbol in the byte string comprises instructions that causes the electronic device to:
multiply each symbol in the byte string by the radix raised to a respective power of the position of each respective symbol in the byte string; and
perform modulo arithmetic on the result of each multiplication with the radix as the modulus.

9. The electronic device of claim 7, wherein the cryptographic function comprises a format preservation encryption algorithm in accordance with an FF1 mode, wherein a variable “y” of the FF1 mode in step 6(iv) is limited in size to radix^{m}, where m is half the length of the cryptographic sentence.

10. The electronic device of claim 9, wherein the modulo operation described at step 6(vi) of the FF1 mode is not performed.

11. The electronic device of claim 7, wherein the cryptographic function comprises a format preservation encryption algorithm in accordance with an FF3 mode, wherein a variable “y” of the FF3 mode in step 4(iv) is limited in size to radix^{m}, where m is half the length of the cryptographic sentence.

12. The electronic device of claim 11, wherein the modulo operation described at step 4(v) of the FF3 mode is not performed.

13. A method performed by an electronic device for limiting the size of interim results of a format-preserving block cipher implemented by a processor within the electronic device, comprising:
receiving a string of unencrypted data for encrypting the string using a number of rounds, the string comprising symbols of a cryptographic alphabet, the cryptographic alphabet comprising a radix that defines a number of symbols in the cryptographic alphabet;
for each round, calculating an integer limited in size to the radix raised to the power of the number of symbols in half the length of the string; and
calculating an encrypted output based on the integer.

14. The method of claim 13, wherein calculating the integer comprises:
calculating a byte string based on a pseudo-random function;
performing a modulo operation on each symbol in the string; and
summing the result of each of the modulo operations together to form the integer.

15. The method of claim 13, wherein the cryptographic function comprises a format preservation encryption algorithm in accordance with an FF1 mode, wherein a variable “y” of the FF1 mode in step 6(iv) is limited in size to radix^{m}, where m is half the length of the cryptographic sentence.

16. The method of claim 15, wherein the modulo operation described at step 6(vi) of the FF1 mode is not performed.

17. The method of claim 13, wherein the cryptographic function comprises a format preservation encryption algorithm in accordance with an FF3 mode, wherein a variable “y” of the FF3 mode in step 4(iv) is limited in size to radix^{m}, where m is half the length of the cryptographic sentence.

18. The method of claim 17, wherein the modulo operation described at step 4(v) of the FF3 mode is not performed.

19. An electronic device that utilizes a format-preserving block cipher that limits interim results of the format-preserving block cipher, comprising:
an input for receiving unencrypted data;
an output for providing encrypted data;
a memory for storing processor-executable instructions; and
a processor coupled to the input, the output and the memory, for executing the processor-executable instructions that causes the electronic device to:
receive, by the processor, the string of unencrypted data for encrypting the string using a number of rounds, the string comprising symbols of a cryptographic alphabet, the cryptographic alphabet comprising a radix that defines a number of symbols in the cryptographic alphabet;
for each round, calculate an integer limited in size to the radix raised to the power of the number of symbols in half the length of the string;
calculate an encrypted output based on the integer in each round; and
provide the encrypted data to the output.

20. The electronic device of claim 19, wherein the processor-executable instructions that cause the electronic device to calculate the integer comprises instructions that causes the electronic device to:
determine a byte string based on a pseudo-random function;
perform a modulo operation on each symbol in the byte string; and
sum the result of each of the modulo operations together to form the integer.
